(19) United States
(12) Patent Application Publication
(10) Pub. No.: US 2006/0142942 A1
(43) Pub. Date: Jun. 29, 2006

(54) Device and method for creating electronic album using map data

(75) Inventor: Jong-Sun Pyo, Suwon-si (KR)

Correspondence Address: DILWORTH & BARRESE, LLP, 333 EARLE OVINGTON BLVD., UNIONDALE, NY, 11553, US

(73) Assignee: Samsung Electronics Co., Ltd., Suwon-si (KR)

(21) Appl. No.: 11/312,077

(22) Filed: Dec. 20, 2005

(30) Foreign Application Priority Data
Dec. 29, 2004 (KR) 2004-115408

(51) Int. Cl. G01C 21/32

(52) U.S. Cl. 701/211; 701/208

(57) ABSTRACT

A device for creating an electronic album using map data, including a storage device interface for providing interface to a storage device; a map database for storing the map data and Point of Interest (POI) information of specific locations in the map data; a controller for reading images of places visited from the storage device, determining location of each place visited using the POI information and the map data, and recording travel information on the images of places visited; and an image output unit for outputting the images with the travel information recorded thereon. An electronic album containing images of places visited can be created using the map data and the POI data in the car navigation system, which improves utilization of the car navigation system. At a later time, the electronic album may remind the user of the travel memories.

### PRIORITY

This application claims priority under 35 U.S.C. §119 to an application entitled “Device and Method for Creating Electronic Album Using Map Data” filed with the Korean Intellectual Property Office on Dec. 29, 2004 and assigned Serial No. 2004-115408, the contents of which are incorporated herein by reference.

### BACKGROUND OF THE INVENTION

1. Field of the Invention

The present invention relates to a car navigation system, and more particularly to a device and method for creating an electronic album with images taken during travel using map data in a car navigation system.

2. Description of the Related Art

Generally, navigation systems mounted in various moving vehicles, such as ships, aircraft and cars, provide drivers with various helpful information on current locations of moving vehicles, optimal routes to chosen destinations and dynamic route guidance. The car navigation systems store map information covering the whole of a country and Point of Interest (POI) information indicating famous regions and buildings or roads on each digital map, and offer route guidance and safe-driving instructions using the stored information.

An ever-increasing number of drivers use car navigation systems. Due to the proliferation of the five-day work week, people want to enjoy certain holidays for non-work-related leisure activities and trips by car. While driving for such leisure or trip purposes, they utilize car navigation systems to have optimal route guidance and driving instructions so as to safely reach their destination. However, conventional car navigation systems cannot be used as means for a personal entertainment function.

During trips, people generally carry a digital camera, digital camcorder or mobile phone with a built-in camera to take photographs or motion pictures. Since most digital cameras, camcorders and camera phones use an external storage device with a limited amount of memory, their possible operating time may also be limited. In other words, due to the restrictive capacity of the external storage device, users can take and record only a limited number of photos or motion pictures. In addition, it is difficult to manage large data amounts of photographs or motion picture files in a digital camera, camcorder or mobile phone.

Users may upload photographs or motion picture files stored in an external storage device to a Personal Computer (PC) or Internet for the management of the photographs or the motion picture files. However, it is difficult to use a PC or the Internet to upload photographs or motion picture files while traveling or engaging in leisure activities.

As a solution to the above problems, a car navigation system can be used to effectively manage photographs or motion picture files stored in an external storage device, such as a digital camera, digital camcorder or mobile phone with a built-in digital camera.

### SUMMARY OF THE INVENTION

Accordingly, the present invention has been made to solve the above-mentioned problems occurring in the prior art, and an object of the present invention is to provide a device and method for uploading photographs and motion pictures stored in an external storage device to a large capacity storage device using a car navigation system and creating an electronic album containing the photographs and the motion pictures.

Another object of the present invention is to provide a device and method for recording travel information on photographs and motion pictures read from an external storage device using map data and POI data in a car navigation system and creating an electronic album containing the photographs and motion pictures with the travel information recorded thereon.

Still another object of the present invention is to provide a device and method for recording travel information on photographs and motion pictures read from an external storage device in a car navigation system and creating an electronic album which links the photographs and motion pictures with the travel information recorded thereon to corresponding POI data.

In order to accomplish the above objects of the present invention, there is provided a device for creating an electronic album using map data, including a storage device interface for providing interface to a storage device; a map database for storing the map data and POI information of specific locations in the map data; a controller for reading images of places visited from the storage device, determining a location of each place visited using the POI information and the map data, and recording travel information on the images of places visited; and an image output unit for outputting the images with the travel information recorded thereon.

In accordance with another aspect of the present invention, there is provided a device for creating an electronic album using map data, including a storage device interface for interfacing to a storage device; a map database for storing the map data and POI information of specific locations in the map data; a controller for reading images of places visited from the storage device, recording travel information on the images of places visited and storing the images of places visited with the travel information recorded thereon in relation to the POI information; and an image output unit for outputting an image of a place related to a specific POI according to a user's demand.

In accordance with still another aspect of the present invention, there is provided a method for creating an electronic album using map data, including reading images of places visited from storage in a storage device; determining location of each place visited using POI information of the map data; recording travel information on the images of places visited; and outputting the images with the travel information recorded thereon.

In accordance with still another aspect of the present invention, there is provided a method for creating an electronic album using map data, including reading images of places visited stored in a storage device; recording travel information on the images of places visited; storing the images of places visited with the travel information recorded thereon in relation to POI information of the map data; and outputting an image of a place related to a specific POI according to a user's demand.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram of a device for creating an electronic album using map data according to the present invention;

FIG. 2 is a flow chart showing a process for creating an electronic album using map data according to a first embodiment of the present invention;

FIG. 3 illustrates an electronic album created according to the first embodiment of the present invention; and

FIG. 4 is a flow chart showing a process for creating an electronic album using map data according to a second embodiment of the present invention.

### DETAILED DESCRIPTION OF THE PREFERRED EMBODIMENT

Hereinafter, preferred embodiments of the present invention will be described with reference to the accompanying drawings. In the following description of the present invention, a detailed description of known functions and configurations incorporated herein will be omitted when it may make the subject matter of the present invention unclear.

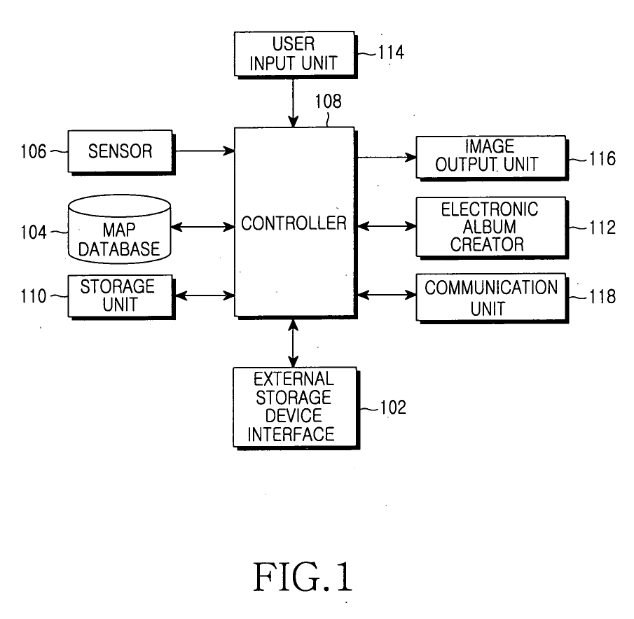

FIG. 1 is a block diagram of a device for creating an electronic album using map data according to the present invention. Referring to FIG. 1, the device for creating an electronic album includes an external storage device interface 102, a map database 104, a sensor 106, a controller 108, a storage unit 110, an electronic album creator 112, a user input unit 114, an image output unit 116 and a communication unit 118.

The external storage device interface 102 provides interface between a car navigation system and an external storage device. The external storage device can be a memory card, such as a Compact Flash (CF) card, Secure Digital (SD) card or T-flash (an ultra compact SD) card embedded in a digital camera, camcorder or mobile camera phone.

The map database 104 stores digital map data covering the whole of a country and POI data indicating famous regions, roads or buildings on each digital map.

As a means for tracking the current location of a moving object (e.g. a car), the sensor 106 includes a Global Positioning System (GPS) sensor and a Dead Reckoning (DR) sensor. The GPS sensor receives GPS signals and detects location information (geometric coordinates x, y and z) and current time information t of a car. The DR sensor is a sensor detecting its own relative location and moving direction based on previous location information. The DR sensor 12 detects the velocity v and the steering angle θ of a car. The sensor 106 calculates the current location of the car based on the location information (x, y, z) and time information t obtained through the GPS sensor and the velocity v and steering angle θ obtained through the DR sensor.

When an external storage device, i.e. a memory card, such as a CF card, SD card or T-flash card, is inserted into the electronic album creating device, the controller 108 reads images (such as photographs or motion pictures) of a place visited from the external storage device and tracks the current location of the car to determine the location of the place visited. The controller 108 performs a map-matching based on the location of the place visited and the map data, and searches for corresponding POI information based on the map-matching results. The POI information shows famous regions, buildings or roads on every digital map. If a place visited is a famous region, building or road, the possibility of detecting corresponding POI information will be high. According to the presence or absence of corresponding POI information, the controller 108 records travel information on the images read from the external storage device. To be specific, when corresponding POI information is detected, the controller 108 records travel information including the travel date/time, travel route and detected POI information on the images. When no corresponding POI information is detected, the controller 108 records travel information including map information on the map-matched point, instead of POI information.

The storage unit 110 can be a Hard Disk Drive (HDD), Compact Disk (CD) or Digital Versatile Disk (DVD) capable of storing relatively large amounts of data compared to the external storage device: The storage unit 110 stores images with travel information recorded thereon. For more effective management of the images, the storage unit 110 can store the images in the order of date, time and POI included in the travel information.

The electronic album creator 112 creates an electronic album containing the images of places visited with corresponding travel information recorded thereon. The electronic album creator 112 may include aCD or a DVD. With the creation of an electronic album using the images of places visited from the storage unit 110, the electronic album creator 112 records the created electronic album on CD or DVD.

The user input unit 114 can be a keypad or a touch pad for providing a user interface. The user input unit 114 transfers a signal of any user demand to the controller 108.

The image output unit 116 can be a Liquid Crystal Display (LCD) or a Cathode Ray Tube (CRT). According to the present invention, the image output unit 116 displays images of places visited and travel information. The image output unit 116 also displays pictures or menus necessary to record travel information on the images of places visited. In addition, when the user inputs a demand for images related to a specific POI on the map data, the image output unit 116 displays the images of a specific place related to the specific POI.

The communication unit 118 transmits the created electronic album to the Internet or a PC through a wired or wireless communication network.

As explained above, the device for creating an electronic album using map data can store images (photographs or motion pictures) taken using a mobile phone or a digital camera, together with corresponding location information based on the map data and the POI data. Also, the device can create an electronic album containing images classified by location.

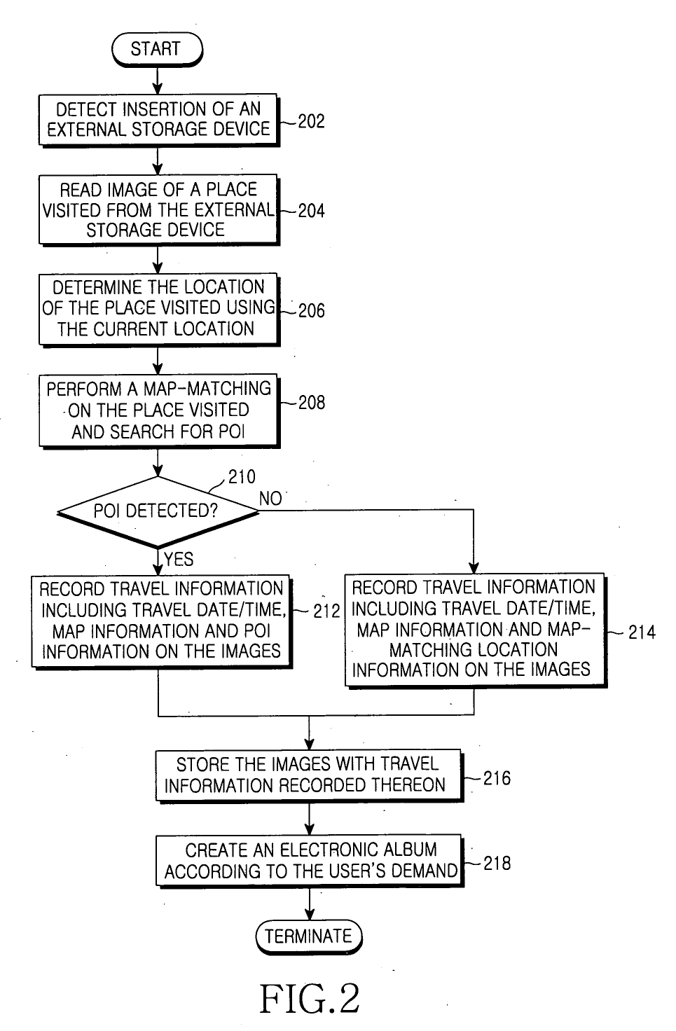

Hereinafter, a process for creating an electronic album using map data will be explained in detail with reference to the flowchart of FIG. 2. The controller 108 detects the insertion of the external storage device at step 202. In other words, the controller 108 detects when a memory card, such as a CF card, SD card or T-flash card for storing photographs or motion pictures taken through a digital camera, camcorder or mobile camera phone, is inserted into the external storage device interface 104.

When the external storage device is inserted, the controller 108 reads images (such as photographs or motion pictures) of a place visited from the external storage device through the external storage device interface 104 at step 204.

At step 206, the controller 108 determines the location of the place visited based on the current location calculated by the sensor 106. To be specific, when the current location of a car is input by the sensor 106, the controller 108 determines that the current location input is the location of the place visited. When the current location of the car is not input by the sensor 106, the controller 108 determines that the last stored location of the car is the location of the place visited.

At this time, the controller 108 may determine the location of the place visited using the POI information in the map database selected by the user, as well as the current location of the car inputted by the sensor 106. The controller 108 then records travel information on the images (photographs or motion pictures of the place visited) based on the determined location. After determination of the location of the place visited, the controller 108 performs a map-matching on the place visited at step 208 and then searches for corresponding POI information based on the map-matching results. In other words, the controller 108 matches the location of the place visited on a digital map and then searches for POI information corresponding to the matched point. The POI information shows famous regions, buildings or roads on each digital map. If the place visited is a famous region, building or road, the possibility of detecting corresponding POI information will be high.

At step 210, the controller 108 determines whether there is POI information corresponding to the map-matched point. If corresponding POI information is detected, the controller 108 records travel information including the travel date/time, travel route and detected POI information on the images of the place visited at step 212. When no corresponding POI information is detected, the controller 108 records travel information including location information of the map-matched point, instead of POI information, on the images in step 214. In other words, the controller 108 records travel information including the travel date/time, travel route and map-matching location information. The location information of the map-matched point can be a road name, place name, or topographical feature such as a river, or landmark on the map-matched point. When the images of the place visited are photographs, the travel information can be recorded in form of an image at a desired position on each photograph. When the images are motion pictures, the travel information can be recorded in form of an image at a desired position of the beginning of each motion picture. A picture for recording the travel information is output to the image output unit 116 so that the user can directly modify the position and size of the travel information on each image.

After recording the travel information on the images of the place visited, the controller 108 proceeds to step 216 to store the images with travel information recorded thereon in the storage unit 110 which is a HDD, CD or DVD.

When the user inputs a demand for creation of an electronic album, the controller 108 creates an electronic album containing the images stored in the storage unit 110 at step 218 and records the electronic album on CD or DVD.

Map data can also be stored in the CD or DVD recording the electronic album using the map database in the car navigation system, thereby enabling the user to easily find out the location of the place visited (where photographs were taken) on the map.

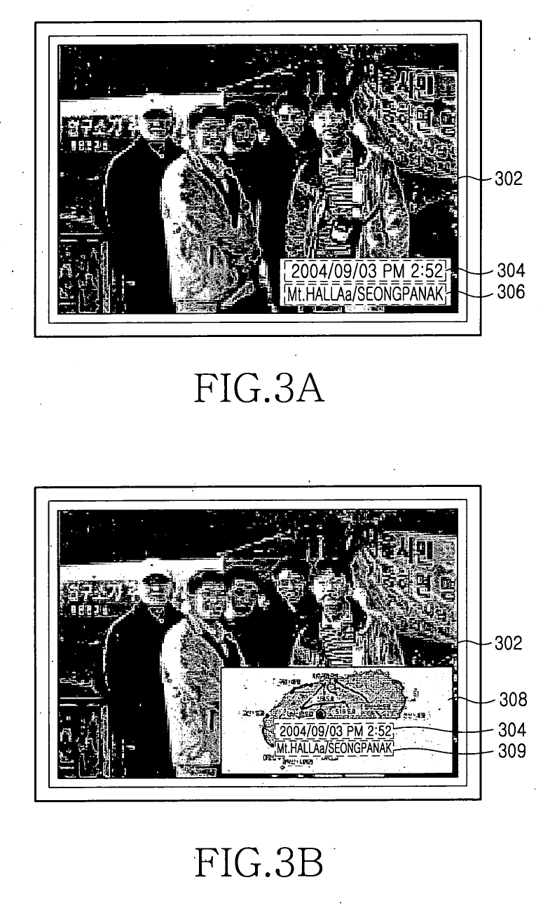

FIG. 3 illustrates an electronic album created according to the present invention. As illustrated in FIG. 3(a), travel information including travel date/time 304 and POI information 306 can be recorded on an image 302 of a place visited. Alternatively, travel information including travel date/time 304, route information 308 and map-matching location information 309 can be recorded on the image 302 as illustrated in FIG. 3(b).

During the operation of the car navigation system, points related to any stored photographs or motion pictures are indicated with a specific icon on the map data displayed on the screen. If the navigation system has a touch screen, the user may touch the icon on a desired point on the map to read and display any photograph or motion picture recorded in relation to that point. For example, a person who travels around Jeju Island can store and manage images photographed at each place visited on the island. Also, the traveler can indicate every point related to the stored images with a specific icon on the map data offered for navigation. When the user zooms in on a map for a closer, more detailed view, the icon indicating the presence of a related image is placed on more accurate locations on the map data.

The image 302 can be a photograph or a motion picture taken at a specific place during travel using a camera phone, digital camera or camcorder. The travel date/time 304 is the accurate date and time when the photograph or motion picture was taken. The POI information 306 shows a point of interest corresponding to the place visited. The route information 308 is a map image with the location of the place visited and the travel route indicated thereon. Every place visited and the travel route from the starting point can be indicated on the route information. The map-matching location information 309 is an indication of the place visited using a name representing a topographical feature (for example, “near Mt. Halla”).

The user may travel to two or more places and take photographs or motion pictures at each place. In accordance with the first embodiment of the present invention, whenever the user inserts the external storage device to the electronic album creating device, photographs or motion pictures taken at each place are stored with corresponding travel information recorded thereon. For example, photographs or motion pictures taken at place I are stored with travel information corresponding to place 1, and those taken at place 2 with travel information corresponding to place 2. After creation of an electronic album containing images of places visited with the corresponding travel information recorded thereon, the electronic album is recorded on CD or DVD. The electronic album can be created to contain all the images of places visited with the travel information. Alternatively, the electronic album can contain only the images of one or more specific places with the corresponding travel information and be recorded on CD or DVD.

In accordance with the first embodiment of the present invention, the electronic album creating device records travel information including POI information on photographs or motion pictures taken at each place visited. In accordance with the second embodiment of the present invention, the device detects a specific location as selected by the user using POI information of the map database and records travel information including related photographs or motion pictures on the detected location.

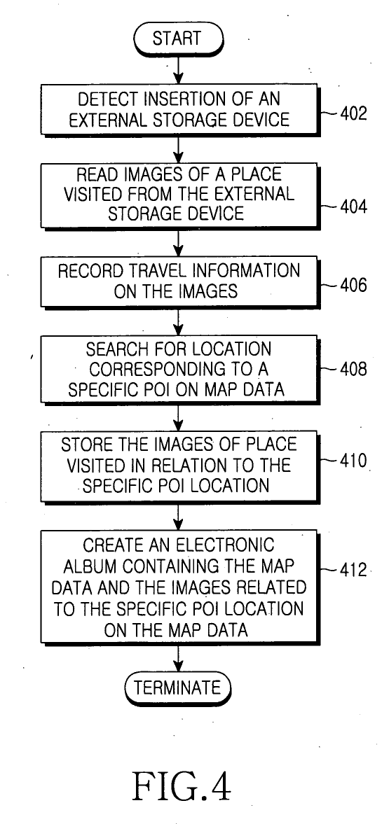

FIG. 4 is a flow chart showing a process for creating an electronic album using map data according to the present invention. Referring to FIG. 4, the controller 108 detects the insertion of an external storage device at step 402. In other words, the controller 108 detects when a memory card, such as a CF card, SD card or T-flash card for storing photographs or motion pictures taken through a digital camera, camcorder or mobile camera phone, is inserted into the external storage device interface 104.

When the external storage device is inserted, the controller 108 reads images (such as photographs or motion pictures) of a place visited from the external storage device through the external storage device interface 104 at step 404.

Then the controller 108 records travel information on the images at step 406. The travel information may include a travel date/time and an explanation of the place visited. After recording the travel information, the controller 108 detects a location corresponding to a specific POI on the map data. In other words, the controller 108 searches for specific POI information selected by the user and detects a location corresponding to the detected POI information.

Upon detecting the location corresponding to the POI information, the controller 108 proceeds to step 410 to store the images with travel information recorded thereon in relation to the detected location. At step 412, the controller 108 creates an electronic album containing the images related to the location of the specific POI on the map data. The created electronic album can be recorded on CD or DVD.

In accordance with the present invention, images related to a specific POI are output on the map data upon the user's demand. Therefore, the user can find locations on the map at which photographs or motion pictures were taken during travel. Also, while driving with route guidance offered on the map data, the user can view the images of places visited that have been previously stored in relation to certain locations on the map.

As explained above, the present invention provides a device and method for moving data stored in an external storage device, such as a digital camera or a camera phone, to a car navigation system, thereby enabling the continued use of the external storage device and solution to the problems associated with the limited storage capacity of the external storage device.

An electronic album containing images of places visited can be created using the map data and the POI data in the car navigation system, which improves utilization of the car navigation system. At a later time, the electronic album may remind the user of the travel memories.

If rent-a-car firms apply the present invention to the navigation systems in their cars, they will be able to offer differentiated, high-quality services through the creation of electronic albums for the customers.

Although preferred embodiments of the present invention have been described for illustrative purposes, those skilled in the art will appreciate that various modifications, additions and substitutions are possible, without departing from the scope and spirit of the invention as disclosed in the accompanying claims, including the full scope of equivalents thereof.

What is claimed is:

1. A device for creating an electronic album using map data, comprising:
a storage device interface for interfacing to a storage device;
a map database for storing the map data and Point of Interest (POI) information of specific locations in the map data;
a controller for reading images of places visited from the storage device, determining location of each place visited using the POI information and the map data, and recording travel information on the images of places visited; and
an image output unit for outputting the images with the travel information recorded thereon.

2. The device as claimed in claim 1, wherein said travel information includes a travel time/date and POI information of each place visited.

3. The device as claimed in claim 1, wherein said controller records travel information including a travel date/time and POI information corresponding to each place visited on the images when the corresponding POI information is detected, or travel information including map information of each place visited on the images when no corresponding POI information is detected.

4. The device as claimed in claim 1, further comprising a sensor for calculating a current location to determine the location of each place visited.

5. The device as claimed in claim 1, further comprising an electronic album creator for creating an electronic album containing the images of places visited with the travel information recorded thereon.

6. The device as claimed in claim 5, wherein said electronic album creator records the created electronic album on Compact Disk (CD) or Digital Versatile Disk (DVD).

7. The device as claimed in claim 5, further comprising a communication unit for transmitting the created electronic album to the Internet or a Personal Computer (PC) through a wireless communication network.

8. The device as claimed in claim 1, further comprising a storage unit for storing the images of places visited with the travel information recorded thereon.

9. The device as claimed in claim 8, wherein said storage unit stores the images of places visited in the order of date, time and POI included in the travel information.

10. The device as claimed in claim 8, wherein said storage unit is any one selected from a Hard Disk Drive (HDD), Compact Disk (CD) or Digital Versatile Disk (DVD).

11. The device as claimed in claim 8, wherein said storage unit is a memory card selected from a Compact Flash (CF) card, Secure Digital (SD) card and T-flash card.

12. The device as claimed in claim 8, wherein said images of places visited are photographs or motion pictures.

13. A device for creating an electronic album using map data, comprising:
a storage device interface for interfacing to a storage device;
a map database for storing the map data and Point of Interest (POI) information of specific locations in the map data;
a controller for reading images of places visited from the storage device, recording travel information on the images of places visited and storing the images of places visited with the travel information recorded thereon in relation to the POI information; and
an image output unit for outputting an image of a place related to a specific POI according to a user's demand.

14. The device as claimed in claim 13, further comprising an electronic album creator for creating an electronic album containing the map data and the images of places related to the POI information on the map data.

15. The device as claimed in claim 13, wherein said electronic album creator records the created electronic album on Compact Disk (CD) or Digital Versatile Disk (DVD).

16. The device as claimed in claim 13, further comprising a communication unit for transmitting the created electronic album to the Internet or a PC through a wireless communication network.

17. The device as claimed in claim 13, wherein said travel information includes an explanation of each place visited.

18. The device as claimed in claim 13, wherein said images of places visited are photographs or motion pictures.

19. A method for creating an electronic album using map data, comprising the steps of:
reading images of places visited stored in a storage device;
determining location of each place visited using Point of Interest (POI) information of the map data;
recording travel information on the images of places visited; and
outputting the images with the travel information recorded thereon.

20. The method as claimed in claim 19, wherein said travel information recording step includes:
searching for POI information corresponding to each place visited;
determining the presence or absence of corresponding POI information;
when corresponding POI information is present, recording travel information including the POI information on the images of places visited; and
when corresponding POI information is not present, recording travel information including map-matching location information on the images of places visited.

21. The method as claimed in claim 19, further comprising storing the images of places visited with the travel information recorded thereon.

22. The method as claimed in claim 19, wherein said travel information includes a travel date/time and POI information.

23. The method as claimed in claim 19, further comprising creating an electronic album containing the images of places visited with the travel information recorded thereon.

24. The method as claimed in claim 23, further comprising recording the created electronic album on Compact Disk (CD) or Digital Versatile Disk (DVD).

25. The method as claimed in claim 23, wherein the electronic album is created to contain images of only selected places if two or more places are visited.

26. The method as claimed in claim 24, wherein the electronic album is created to contain images of all places visited if two or more places are visited.

27. A method for creating an electronic album using map data, comprising the steps of:
reading images of places visited stored in a storage device;
recording travel information on the images of places visited;
storing the images of places visited with the travel information recorded thereon in relation to Point of Interest (POI) information of the map data; and
outputting an image of a place related to a specific POI according to a user's demand.

28. The method as claimed in claim 27, further comprising creating an electronic album containing the map data and the images of places related to the POI information on the map data.

29. The method as claimed in claim 27, further comprising the step of recording the created electronic album on Compact Disk (CD) or Digital Versatile Disk (DVD).

30. The method as claimed in claim 27, further comprising transmitting the created electronic album to the Internet or a Personal Computer (PC) through a wireless communication network.

31. The method as claimed in claim 27, wherein said travel information includes an explanation of each place visited.

32. The method as claimed in any of claims 27, wherein said images of places visited are photographs or motion pictures.
